(19) United States
(12) Patent Application Publication
(10) Pub. No.: US 2002/0074465 A1
(43) Pub. Date: Jun. 20, 2002

(54) Table-top display base

(76) Inventor: Angela S. Suehrstedt, Indianapolis, IN (US)

Correspondence Address: A. James Richardson, 201 North Illinois Street, Suite 1000, P.O. Box 44961, Indianapolis, IN, 46244-0961, US

(21) Appl. No.: 09/740,244

(22) Filed: Dec. 19, 2000

(51) Int. Cl. F16M 11/00; A47G 29/00

(52) U.S. Cl. 248/176.1; 248/694

(57) ABSTRACT

A base for a decorative display includes a disk having upper and lower surfaces bounded by a generally cylindrical edge. A rod has a proximal end fixed to the disk center and has a distal end projecting away from the disk upper surface. A plurality of pins are fixed in a row to a vertical center of the disk edge and project radially outward. A fastening element is fixed to the rod distal end so as to project upward in the same general direction as the rod. A plurality of substantially transparent polymeric mono-filament strands join the plurality of pins fixed to the disk edge to the fastening element fixed to the rod distal end so as to form a generally cone shaped envelope for enclosing a decorative display positioned on the disk upper surface.

### BACKGROUND OF THE INVENTION

The present invention is directed generally to ornamental or decorative displays, and to foundational stands or bases for such decorative displays, generally of a size that can be supported by a table. The invention is intended to provide a novel platform upon which an artisan can create a wide variety of decorative displays to carry out any number of themes of choice.

Display stands are know having a wide variety of characteristics.

Generally, displays of products can be divided into three general categories. Some displays, such as card racks, are designed to place a variety of products in easy reach of prospective purchasers to facilitate selection. Other displays, such as precious jewelry cases, are intended to present the products for easy viewing, but still limit the access by the viewer. Still other displays, usually non-commercial in design such as an architect's model, are intended to present a group of objects in a thematic presentation merely as a communication between the creating artist and the viewing public, which is the focus of the present invention.

The display of a group of objects in a thematic presentation can be facilitated by the adoption of some framework in which to express the concepts and ideas. Examples of such frameworks are shadow boxes, diorama boxes, and flat table tops with or without transparent protective shields. The framework is intended to focus the viewer's attention on the thematic presentation by defining a boundary between the expressive work and the surrounding reality. Both physical structures and eye-catching features can be employed as boundary mechanisms.

The present invention is intended to present a novel framework for expressive presentations. It is desirable that such frameworks be structurally sound so that the presentation can be easily transported from one location to another. It is also desirable that such frameworks be inexpensive to create so that its cost does not significantly impact the expressive work itself.

### SUMMARY OF THE INVENTION

A base or framework for a decorative display according to the present invention comprises a disk having an upper surface and a lower surface bounded by an edge. A proximal end of a rod is fixed to the disk at a central location, the rod having a distal end projecting away from the disk upper surface. A plurality of fastening elements are fixed to the disk edge, and at least one fastening element is fixed to the rod distal end. A plurality of strands join the fastening elements fixed to the disk edge to the fastening element fixed to the rod distal end so as to form a generally cone shaped envelope for enclosing a decorative display positioned on the disk upper surface.

The disk preferably has an upper surface and lower surface are parallel to each other, but the upper surface can include other structural features and elements as are desired by the artisan to carry out a desired theme. While the upper surface of the base can provide a direct mounting surface for decorative displays, it is also possible to add one or more additional disks situated on said upper surface, the additional disks having an edge space inwardly from the edge of the first disk. Where the upper surface of the disk is not parallel to the lower surface of the disk, it is generally desirable to orient the rod so that it is normal to the disk lower surface so that it appears to be arranged vertically with respect the any underlying surface upon which the disk lower surface may be positioned. The disk can be made of any structurally sound material such as wood, wafer-board, ceramic, metal, etc.

The disk edge is preferably cylindrical and the rod proximal end is preferably fixed to the cylindrical disk at the center of the disk so that the cone shaped envelope is uniformly arranged around the periphery of the base. In certain situations it may be desirable to incline the rod with respect to the disk or to fix the rod to the disk at a position offset somewhat from the center of the disk to achieve a specially skewed arrangement of the cone shaped envelope formed by the strands. The rod itself should be fabricated from a structurally sound material which will withstand no only the small compression and bending forces exerted by the strands, but also any expected transportation of the display, once it is created.

The fastening elements are preferably fixed to the disk edge as a uniformly spaced row of pins projecting radially outward from a central portion of the disk edge, however the exact placement of the pins in a single row is not necessary to achieve a substantially uniform spacing of the strands. Furthermore, some special effects for the cone formed by the strands can be achieved by developing a patterned or skewed arrangement for the fastening elements around the disk. The fastening element fixed to the rod distal end preferably comprises a single pin projecting upward therefrom so as to form a single apex for the cone, however it may be possible to use more than one pin in close proximity to each other in certain circumstances.

As a general rule, the plurality of strands is preferably formed from a polymeric mono-filament line that is substantially transparent so as to not block the view of any material elements arranged on the upper surface of the base. At the same time it is desirable for the surface of the strands to have some light disrupting effect so that any lighted elements placed on the upper disk surface may gain in attractiveness. A suitable material for forming the strands is 3# to 20# mono-filament fishing line, preferably about 8#, but more dramatic effects can be achieved by using ribbon having any variety of characteristic colors, thickness, and even lace pattern openings.

While a number of variations have been identified in this summary, it is anticipated that other variations and modifications will become apparent to skilled artisans upon consideration of the following description of a preferred embodiment which references the attached drawings illustrating the best way known to the inventor to construct a decorative display base of the present invention.

### BRIEF DESCRIPTION OF THE DRAWINGS

FIG. 1 is a perspective view of a display base of the present invention.

FIG. 2 is a perspective view of the display base of FIG. 1 with an added stage.

### DESCRIPTION OF THE PREFERRED EMBODIMENT

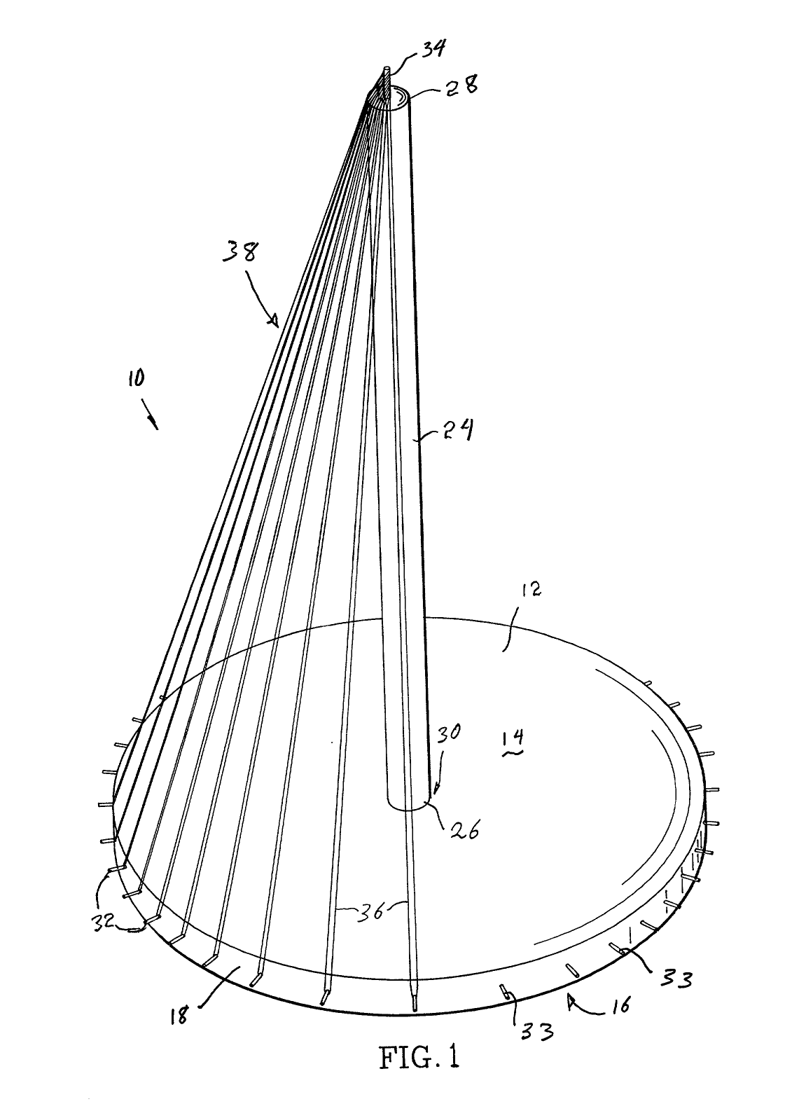

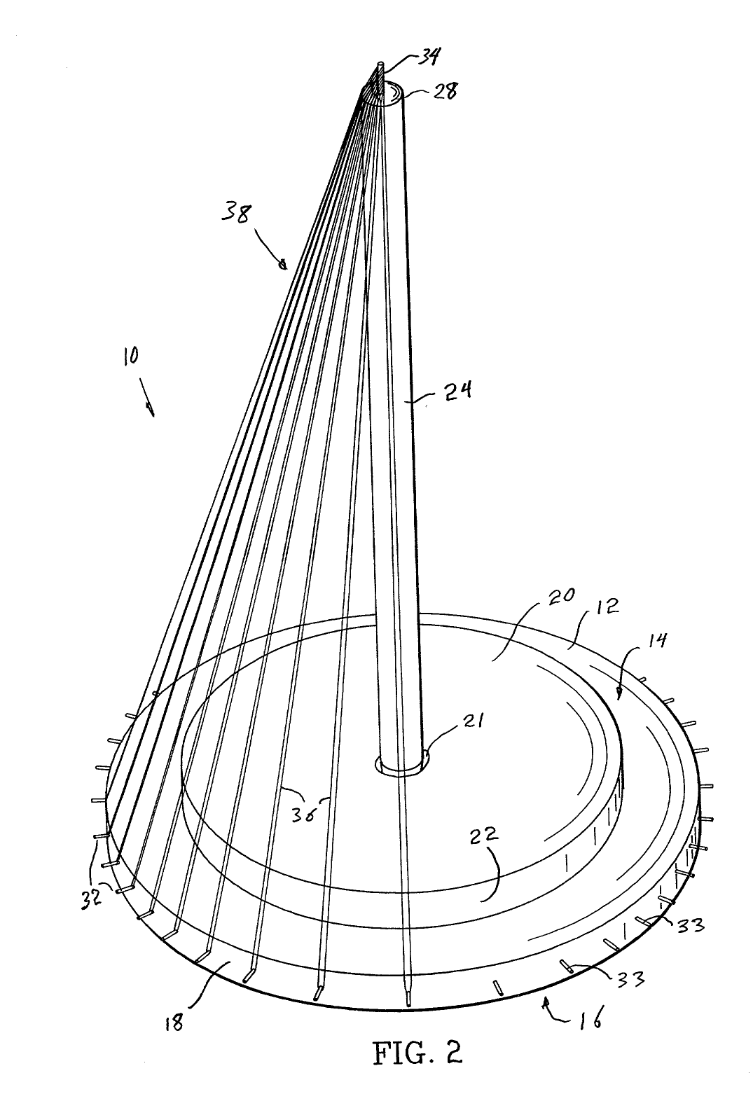

A base or framework 10 for a decorative display according to the present invention is shown in FIG. 1 to comprise a disk 12 having an upper surface 14 and a lower surface 16 bounded by an edge 18. The disk upper surface 14 and lower surface 16 are generally parallel to each other. The upper surface 14 is intended to support such structural features and elements as are desired by an artisan to carry out a desired expression of a theme by way of a decorative display. It is also possible to add one or more additional stages 20 as shown in FIG. 2. Each additional stage 20 is generally situated on the upper surface 14 with the additional stages having edges 22 spaced inwardly from the edge 18 of the first disk 12 and need not be circular. While it is important for the integrity of the base 10 that the disk 12 be made of a structurally sound material that will support the various elements of the base 10 and any display placed thereon, the additional stages 20 need not be as sturdy and can be formed of materials that can be shaped more easily such as sheet Styrofoam, papier-mâché, etc.

The base or framework 10 also includes a rod 24 having a proximal end 26 and a distal end 28. The proximal end 26 of the rod 24 is fixed to the disk 12 at a central location 30 so that the rod distal end 28 projects away from the disk upper surface 14. Any additional stages 20 can include a central opening 21 that will permit the additional stage to be telescopically placed over the rod distal end 28 and lowered into the desired position.

The base or framework 10 also includes a plurality of fastening elements 32 fixed to the disk edge 18, and at least one fastening element 34 fixed to the rod distal end 28. A plurality of strands 36 join the fastening elements 32 fixed to the disk edge 18 to the fastening element 34 fixed to the rod distal end 28 so as to form a generally cone shaped envelope 38 for enclosing a decorative display (not shown) positioned on the disk upper surface 14.

The disk edge 18 is preferably cylindrical and the rod proximal end 26 is preferably fixed to the cylindrical disk at the center of the disk 12 so that the cone shaped envelope 38 is uniformly arranged around the periphery of the base 10. Where the disk upper surface 14 is not parallel to the disk lower surface 16, it is generally desirable to orient the rod 24 so that it is perpendicular to the disk lower surface 16 so that the rod 24 appears to be arranged vertically with respect the any underlying surface upon which the base 10 may be positioned. In certain situations it may be desirable to incline the rod 24 with respect to the disk 12 or to fix the rod to the disk at a position offset somewhat from the center of the disk to achieve a specially skewed arrangement of the cone shaped envelope formed by the strands 36. The fastening elements 32 are preferably fixed to the disk edge in a regular pattern, and can constitute a uniformly spaced row of pins 33 projecting radially outward from a central portion of the disk edge 18 as shown in FIGS. 1 and 2. The exact placement of the pins 33 in a single row is not necessary to achieve a substantially uniform spacing of the strands 36. Furthermore, some special effects for the cone 38 can be achieved by developing a patterned or skewed arrangement for the fastening elements 32 around the disk 12, particularly if used in conjunction with more than one fastening element 34 on the distal end 28 of the rod 24. Preferably, the envelope 38 formed by the plurality of strands 36 is advantageously used to create unique light patterns, whether from external or internal illumination, that enhance the visual boundary of the completed display without distracting from the thematic presentation.

Other variations of the present invention will be apparent to those skilled in the art which still come within the scope and spirit of the prior description as well as the following claims.

What is claimed is:

1. A base for a decorative display comprising a disk having an upper surface and a lower surface bounded by an edge, a rod having a proximal end fixed to the disk at a central location and having a distal end projecting away from the disk upper surface, a plurality of fastening elements fixed to the disk edge, at least one fastening element fixed to the rod distal end, and a plurality of strands joining the fastening elements fixed to the disk edge to the at least one fastening element fixed to the rod distal end so as to form a generally cone shaped envelope for enclosing a decorative display positioned on the disk upper surface.

2. The base of claim 1 wherein the disk upper surface and lower surface are parallel to each other.

3. The base of claim 1 wherein the disk edge is cylindrical.

4. The base of claim 1 wherein the rod proximal end is fixed to the center of the disk upper surface so that the rod is oriented normal to the disk upper surface.

5. The base of claim 1 wherein the fastening elements fixed to the disk edge comprise a row of pins projecting radially outward from a central portion of the disk edge.

6. The base of claim 1 wherein the at least one fastening element fixed to the rod distal end comprises a single pin projecting upward therefrom.

7. The base of claim 1 wherein the plurality of strands comprise a polymeric mono-filament line.

8. The base of claim 7 wherein the polymeric mono-filament line is substantially transparent.

9. The base of claim 1 further comprising at least one additional disk situated on said upper surface, the at least one additional disk having an edge space inwardly from the edge of the first disk.

10. A base for a decorative display comprising a disk having an upper surface and a lower surface, the upper and lower surfaces being parallel to each other and bounded by a cylindrical edge, a rod having a proximal end fixed to the disk center and having a distal end projecting normally away from the disk upper surface, a plurality of pins fixed in a row to a vertical center of the disk edge and projecting radially outward therefrom, a fastening element fixed to the rod distal end so as to project upward in the same direction as the rod, and a plurality of substantially transparent polymeric mono-filament strands joining the plurality of pins fixed to the disk edge to the at least one fastening element fixed to the rod distal end so as to form a generally cone shaped envelope for enclosing a decorative display positioned on the disk upper surface.
